(19) United States
(12) Patent Application Publication
(10) Pub. No.: US 2014/0002915 A1
(43) Pub. Date: Jan. 2, 2014

(54) LENS MODULE

(71) Applicant: HON HAI PRECISION INDUSTRY CO., LTD., New Taipei (TW)

(72) Inventor: CHENG-SHIUN WU, New Taipei (TW)

(73) Assignee: HON HAI PRECISION INDUSTRY CO., LTD., New Taipei (TW)

(21) Appl. No.: 13/855,733

(22) Filed: Apr. 3, 2013

(30) Foreign Application Priority Data
Jun. 29, 2012 (TW) 101123612

(51) Int. Cl. G02B 7/02

(52) U.S. Cl. CPC G02B 7/026
USPC 359/830

(57) ABSTRACT

A lens module includes a lens module, a lens group, and a grip ring. The lens group and the grip ring are received in the lens barrel, and the grip ring is positioned at an end of the lens barrel to ensure the lens group in place. The grip ring includes a bottom surface and an outer side surface connected to the bottom surface. The bottom surface is attached to a side surface of the lens group. The outer side surface is spaced from an inner surface of the lens barrel to form an adhesive dispensing gap, and the outer side surface tapers from the bottom surface to a side surface of the grip ring opposite to the bottom surface.

### BACKGROUND

1. Technical Field

The present disclosure relates to optical apparatuses, and particularly to a lens module for an optical imaging device.

2.Description of Related Art

Lens modules generally include a lens barrel, a lens group with a number of optical lenses, and a grip ring. The lens group and the grip ring are received in the lens barrel, and the grip ring is positioned at a side of the lens group for securing the optical lenses in place. In assembly, the grip ring is fixed in lens barrel by dispensing an adhesive in a gap between an outer side surface of the grip ring and an inner surface of the lens barrel. However, because the miniature size of the lens module, the gap is very narrow, therefore, it is difficult to dispense the adhesive in the gap.

What is needed therefore is a lens module addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a cross-sectional view of a lens module, according to a first exemplary embodiment of the present disclosure.

FIG. 2 is a cross-sectional view of a lens module, according to a second exemplary embodiment of the present disclosure.

### DETAILED DESCRIPTION

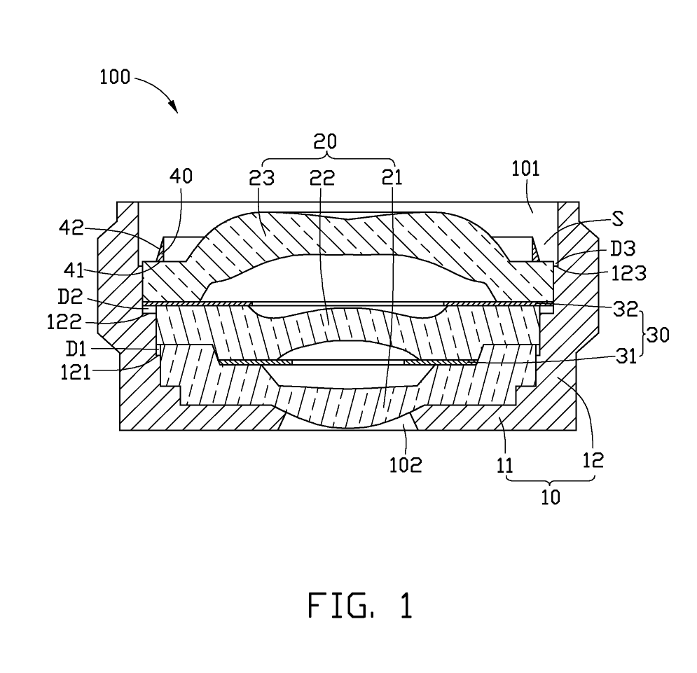

FIG. 1 shows a lens module 100 according to a first exemplary embodiment. The lens module 100 includes a lens barrel 10, a lens group 20, a spacer unit 30, and a grip ring 40. The lens group 20, the spacer unit 30, and the grip ring 40 are received in the lens barrel 100.

The lens barrel 10 defines a receiving space 101 for receiving the lens group 20, the spacer unit 30, and the grip ring 40. The lens barrel 10 includes an end wall 11 and a side wall 12 connected to the end wall 11. The end wall 11 and the side wall 12 cooperatively form the receiving space 101 therebetween. The end wall 11 defines a through hole 102 communicating with the receiving space 101. The side wall 12 includes a first step portion 121, a second step portion 122, and a third step portion 123 formed on an inner surface thereof. The first step portion 121, the second step portion 122 and the third step portion 123 are orderly arranged along an optical axis of the lens module 100.

The lens group 20 includes a first lens 21, a second lens 22, and a third lens 23. The first lens 21, the second lens 22, and the third lens 23 are orderly arranged from the end wall 11 in a direction away from the end wall 11 along the optical axis. The first lens 21 has a positive refraction power, and the second lens 22 and the third lens 23 both have a negative refraction power. The first step portion 121 spaces an outer side surface of the first lens 21 from an inner surface of the lens barrel 10 to form a first slot D1, the second step portion 122 spaces an outer side surface of the second lens 22 from the inner surface of the lens barrel 10 to form a second slot D2, and the third step portion 123 spaces an outer side surface of the third lens 23 from the inner surface of the lens barrel 10 to form a third slot D3.

The spacer unit 30 includes a first spacer 31 and a second spacer 32. The first spacer 31 is positioned between the first lens 21 and the second lens 22 for spacing the first lens 21 and the second lens 22 for a first predetermined distance, and the second spacer 32 is positioned between the second lens 22 and the third lens 23 for spacing the second lens 22 and the third lens 23 for a second predetermined distance.

The grip ring 40 is positioned at a side of the third lens 23 away from the end wall 11. The grip ring 40 includes a bottom surface 41 and an outer side surface 42 connected to the bottom surface 41. The bottom surface 41 attaches on the third lens 23. The outer side surface 42 tapers from the bottom surface 41 to a side surface of the grip ring 40 opposite to the bottom surface 41. In this embodiment, a cross-section of the grip ring 40 is substantial a right-angled triangle. The outer side surface 42 is spaced from the inner surface of the lens barrel 10 to form an adhesive dispensing gap S.

In assembly, an adhesive (not shown) is dispensed in the adhesive dispensing gap S by a glue dispensing device (not shown). The grip ring 40 can prevent the adhesive from flowing to an effective optical area of the lens group 20, the adhesive adheres the lens group 20 in the lens barrel 10. Because of the tapered shape of the grip ring 40, a top portion of the adhesive dispensing gap S is broader than a bottom portion of the adhesive dispensing gap S, therefore, it is easy to dispense the adhesive into the gap S, thus decreasing the assembling difficulty of the lens module.

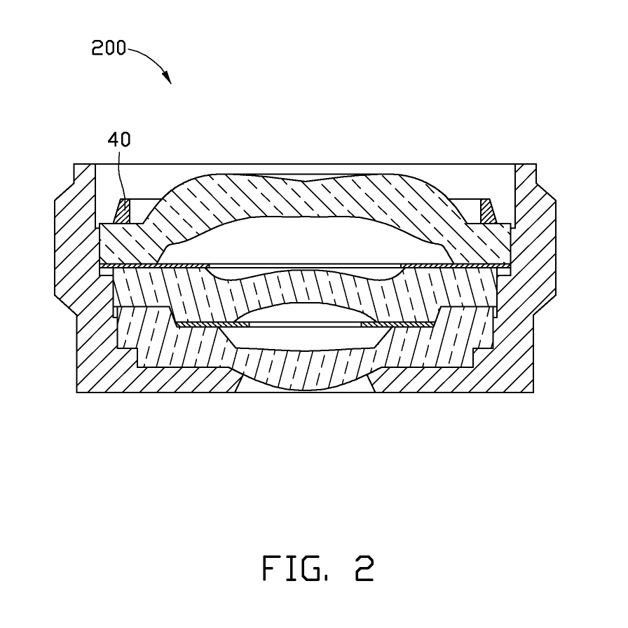

FIG. 2 shows a lens module 200 according to a second exemplary embodiment. In this embodiment, a cross-section of the grip ring 40 is substantial a right-angled trapezoid. The grip ring 40 has a similar function as the grip ring 40 of the first embodiment.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A lens module, comprising:
a lens barrel;
a lens group received in the lens barrel; and
a grip ring received in the lens barrel and positioned at an end of the lens barrel to ensure the lens group in place, the grip ring comprising a bottom surface and an outer side surface connected to the bottom surface, the bottom surface attached on a side surface of the lens group, the outer side surface being spaced from and separated from an inner surface of the lens barrel to form an adhesive dispensing gap, and the outer side surface tapering from the bottom surface to a side surface of the grip ring opposite to the bottom surface.

2. The lens module of claim 1, wherein the lens barrel comprises an end wall and a side wall connected to the end wall, the end wall and the side wall cooperatively define a receiving space, and the receiving space receives the lens group and the grip ring therein.

3. The lens module of claim 1, wherein the lens group comprises a first lens, a second lens, and a third lens, and all of the first lens, the second lens and the third lens are orderly arranged along an optical axis of the lens module.

4. The lens module of claim 3, wherein the first lens has a positive refraction power, and the second and third lens both have a negative refraction power.

5. The lens module of claim 3, wherein the lens module comprises a spacer unit received in the lens barrel.

6. The lens module of claim 5, wherein the spacer unit comprises a first spacer and a second spacer, the first spacer is positioned between the first lens and the second lens, and the second spacer is positioned between the second lens and the third lens.

7. The lens module of claim 5, wherein the lens barrel comprises a first step portion, a second step portion and a third step portion formed on the inner surface of the lens barrel, and the first step portion, the second step portion and the third step portion are arrange along the optical axis.

8. The lens module of claim 7, wherein the first step portion spaces an outer side surface of the first lens from the inner surface of the lens barrel to form a first slot, the second step portion spaces an outer side surface of the second lens from the inner surface of the lens barrel to form a second slot, and the third step portion spaces an outer side surface of the third lens from the inner surface of the lens barrel to form a third slot.

9. The lens module of claim 1, wherein a cross-section of the grip ring is substantial a right-angled triangle.

10. The lens module of claim 1, wherein a cross-section of the grip ring is substantial a right-angled trapezoid.
